(19) United States
(12) Patent Application Publication
(10) Pub. No.: US 2012/0092629 A1
(43) Pub. Date: Apr. 19, 2012

(54) PROJECTION DEVICE

(75) Inventors: Chih-Wei Chang, Hsinchu (TW); Pei-Ching Liu, Hsinchu (TW); Jui-Hsiang Yen, Hsinchu (TW); Chien-Jung Huang, Hsinchu (TW)

(73) Assignee: YOUNG OPTICS INC., Hsinchu (TW)

(21) Appl. No.: 13/177,567

(22) Filed: Jul. 7, 2011

(30) Foreign Application Priority Data
Oct. 15, 2010 (TW) 99135273

(51) Int. Cl. G03B 21/20

(52) U.S. Cl. 353/97; 353/100; 353/101

(57) ABSTRACT

A projection device including an optical engine base, a light source, a light valve, and a projection lens is provided. The light source includes a component holder, a light component, and light lens. The component holder is assembled to the optical engine base, and has a component slot and a lens slot communicated with the component slot. The lens slot has at least one slot section plane. The light component is disposed within the component slot. The light lens is disposed within the lens slot, and adapted to form the light generated by the light component into a lighting beam. The light valve and the projection lens are assembled to the optical engine base. The light valve is adapted to convert the lighting beam into an image beam. The projection lens is adapted to convert the image beam into a projection beam.

### CROSS-REFERENCE TO RELATED APPLICATION

This application claims the priority benefit of Taiwan application serial no. 99135273, filed on Oct. 15, 2010. The entirety of the above-mentioned patent application is hereby incorporated by reference herein and made a part of this specification.

### BACKGROUND OF THE INVENTION

1. Field of the Invention

The invention relates to a projection device and more particularly to an optical engine assembly of a micro-projection device.

2. Description of Related Art

Along with the reduced size of projection devices, miniaturized projection devices have been launched in the market. Moreover, miniaturized projection devices are integrated into mobile devices (i.e. mobile phones) to provide projection already. However, in order to further reduce the configuration of projection devices, other than improvements in optical design, the size of mechanism body and image quality are also important.

In the field of projection technology, a light emitting diode (LED) packaging structure is disclosed in Taiwan Patent No. M261835, where an optical lens thereof is surrounded by a carrier ring and disposed on a printed circuit board. A lens module is disclosed in Taiwan Patent No. 200916869, where elastic spacer rings are disposed between each of a plurality of lenses in a lens cone. A television device is disclosed in Taiwan Patent No. 1234399, where a monitor panel is installed on an outer frame body through the clamping of an elastomer component. A fixation mechanism is disclosed in Taiwan Patent No. M 291661, where a buffering pad is disposed in a slot of a fixation component. A projector is disclosed in Taiwan Patent No. 200702877, where a shading device cuts the light generating a distortion region before the light reaches a digital micro mirror device. An optical projection system is disclosed in Taiwan Patent No. 200613884, where a barrier cuff thereof shields a portion of the stray light.

### SUMMARY OF THE INVENTION

The invention relates to a projection device having high image quality.

The invention relates to a projection device configured to enhance assembly precision.

The advantages of the invention are further illustrated from the technical characteristics disclosed in the invention.

To attain one or a portion or all of the objectives aforementioned or other objectives, one embodiment of the invention provides a projection device including an optical engine base, a light source, a light valve, and a projection lens. The light source is adapted to provide a lighting beam. The light valve is assembled to the optical engine base, located on a transmission path of the lighting beam, and adapted to convert the lighting beam into an image beam. The projection lens is assembled to the optical engine base, located on a transmission path of the image beam, and adapted to convert the image beam into a projection beam. The light source includes a component holder, a light component, and a light lens. The component holder is assembled to the optical engine base and has a component slot and a lens slot communicated with the component slot. The lens slot has at least one slot section plane. The light component is disposed within the component slot. The light lens is disposed within the lens slot and adapted to form a light generated by the light component into the lighting beam.

In light of the foregoing, the embodiments of the invention may achieve at least one of following advantages or efficiencies. In the embodiments of the invention, the locating steps among the components may be simplified through the disposition of the light component and the light lens corresponding to the component slot and the lens slot on the component holder respectively. As a consequence, the locating precision among the components may be further increased so as to enhance an image quality of the projection device.

Other objectives, features and advantages of the invention will be further understood from the further technological features disclosed by the embodiments of the invention wherein there are shown and described preferred embodiments of the invention, simply by way of illustration of modes best suited to carry out the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram illustrating a projection device according to an embodiment of the invention.

FIG. 2A is a perspective view showing a light source in FIG. 1.

FIG. 2B is an exploded view showing components in the light source of FIG. 2A.

FIG. 3A is a perspective view illustrating an optical engine base and an optical lens in FIG. 1.

FIG. 3B is an exploded view illustrating the optical engine base and the optical lens in FIG. 3A.

FIG. 4A is a perspective view illustrating the optical engine base and a light valve in FIG. 1.

FIG. 4B is an exploded view showing components of the optical engine base and the light valve in FIG. 4A.

FIG. 5 is a top view showing the optical engine base and a projection lens in FIG. 1.

FIG. 6A is a partial cross-sectional view taken along line I-I in FIG. 5.

FIG. 6B is a partial cross-sectional view taken along line II-II in FIG. 5.

FIG. 7 is a top view showing the optical engine base, the light valve, and the projection lens in FIG. 1.

FIGS. 8A and 8B are cross-sectional views taken along line III-III in FIG. 7.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

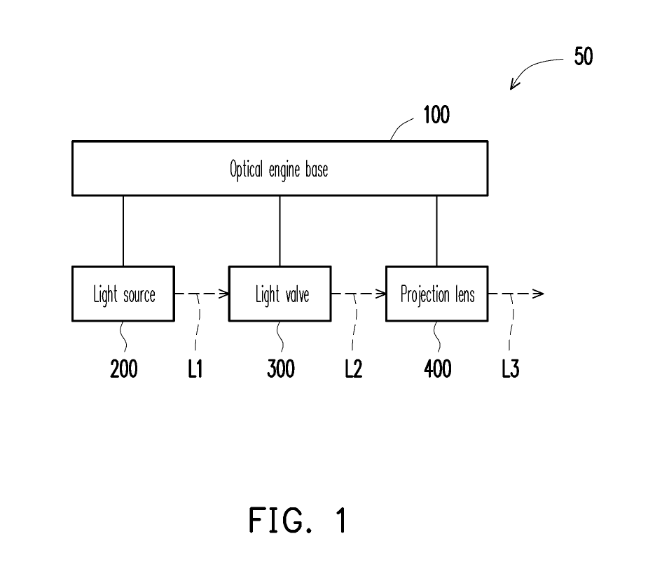

Referring to FIG. 1, a projection device 50 of the present embodiment includes an optical engine base 100, a light source 200, a light valve 300, and a projection lens 400. The light source 200 is assembled to the optical engine base 100 and adapted to provide a lighting beam L1. The light valve 300 is assembled to the optical engine base 100, located on a transmission path of the lighting beam L1, and adapted to convert the lighting beam L1 into an image beam L2. The projection lens 400 is assembled to the optical engine base 100, located on a transmission path of the image beam L2, and adapted to convert the image beam L2 into a projection beam L3.

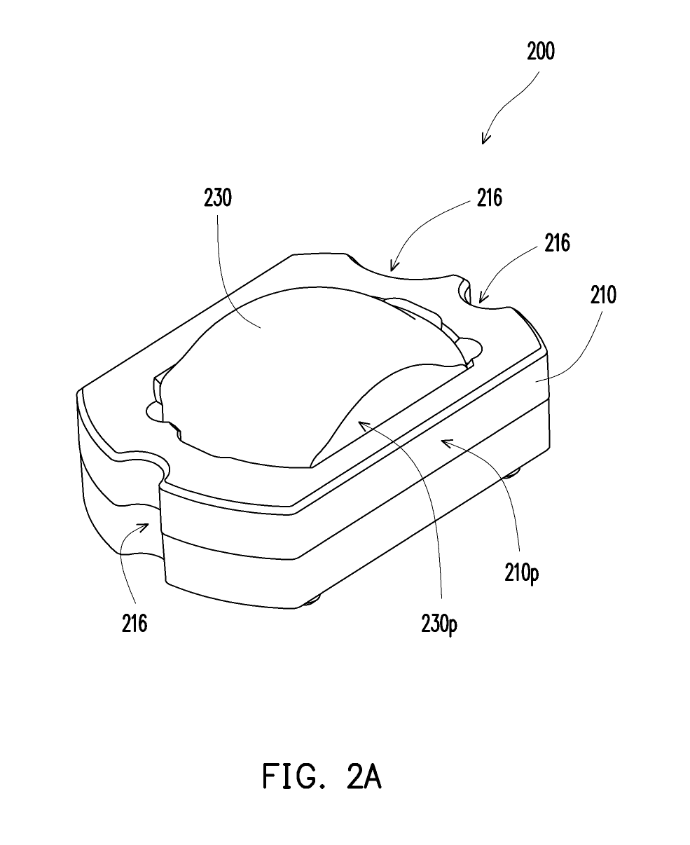

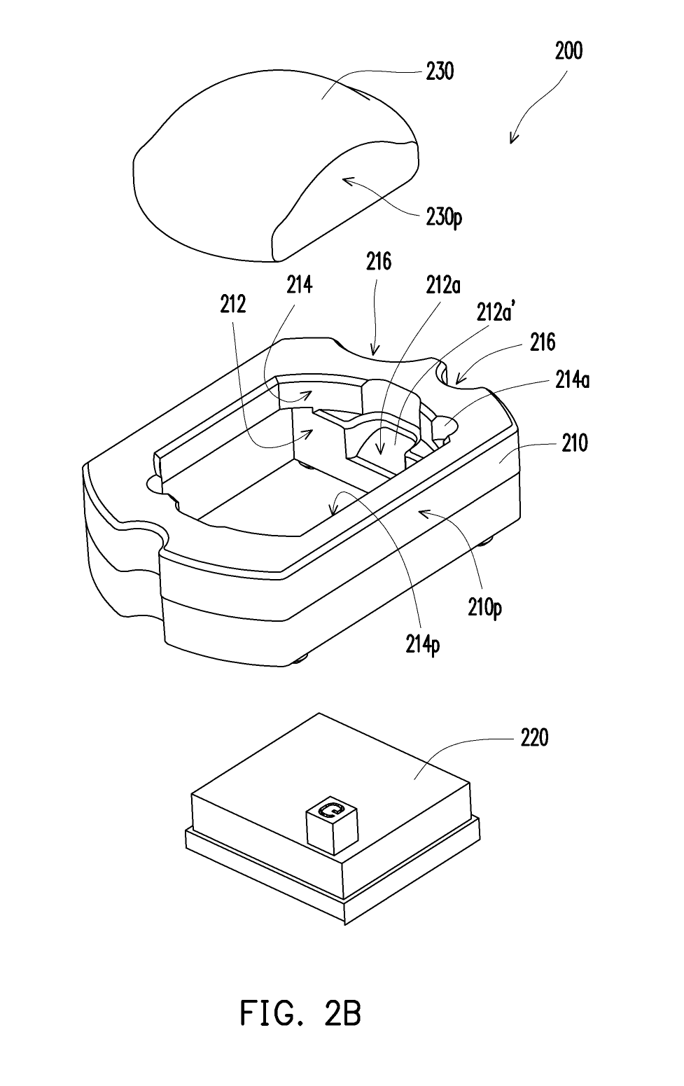

Referring to FIGS. 2A and 2B, the light source 200 includes a component holder 210, a light component 220, and a light lens 230. In the present embodiment, the light component 220 is, for example, a light emitting diode (LED) package.

The component holder 210 is assembled to the optical engine base 100 in FIG. 1 and has a component slot 212 and a lens slot 214 communicated with the component slot 212. The lens slot 214 has at least one slot section plane 214p. Here, two slot section planes 214p are shown as an example in the present embodiment. The light component 220 is disposed within the component slot 212. The light lens 230 is adapted to form a light generated by the light component 220 into the lighting beam L1 depicted in FIG. 1. The light lens 230, for example, has two light lens section planes 230p disposed on the two slot section planes 214p of the lens slot 214 respectively, such that an outer edge of the light lens 230 is disposed within the lens slot 214.

Accordingly, the outer edge of the component holder 210 of the present embodiment has two holder section planes 210p, for instance, and the holder section planes 210p are parallel to the slot section planes 214p, for instance. It should be noted that the number of the slot section planes 214p, the light lens section planes 230p, and the holder section planes 210p is determined according to demands of the actual product. In other words, the invention does not limit the number of the slot section planes, the light lens section planes, and the holder section planes.

The component holder 210 has a component gluing slot 212a and a lens gluing slot 214a. Herein, a first glue body (not shown) is disposed on the component gluing slot 212a, so that the light component 220 is fixed to the component slot 212 by disposing the first glue body between the component gluing slot 212a and the light component 220. Moreover, a second glue body (not shown) is disposed on the lens gluing slot 214a, such that the light lens 230 is fixed to the lens slot 214 by disposing the second glue body between the lens gluing slot 214a and the light lens 230.

In the present embodiment, the component gluing slot 212a has a slant surface 212a′ having a slant angle about 45 degree, during a formation of the first glue body, the slant surface 212a′ allows the glue body to flow down the slant surface 212a′ easily due to gravity, so as to increase a connecting area between the light component 220 and the component slot 212. However, as the material characteristics of the first glue body and the like, the connecting area between the component gluing slot 212a and the light component 220, and physical parameters such as structural strength may all be considered in designing the slant angle of the slant surface 212a′. Consequently, the invention does not limit the slant angle of the slant surface.

In the present embodiment, the outer edge of the component holder 210 further has at least one sunken arc 216. Here, three sunken arcs 216 are illustrated in FIGS. 2A and 2B as an example. The sunken arcs 216 are adapted to compensate the shape of an automatic locating detent so as to facilitate a moving operation of the component holder 210 by a robot. Nevertheless, the shape and the number of the sunken arcs 216 may be adjusted depending on the design of the locating detent. That is, the invention does not limit the shape and the number of the sunken arcs.

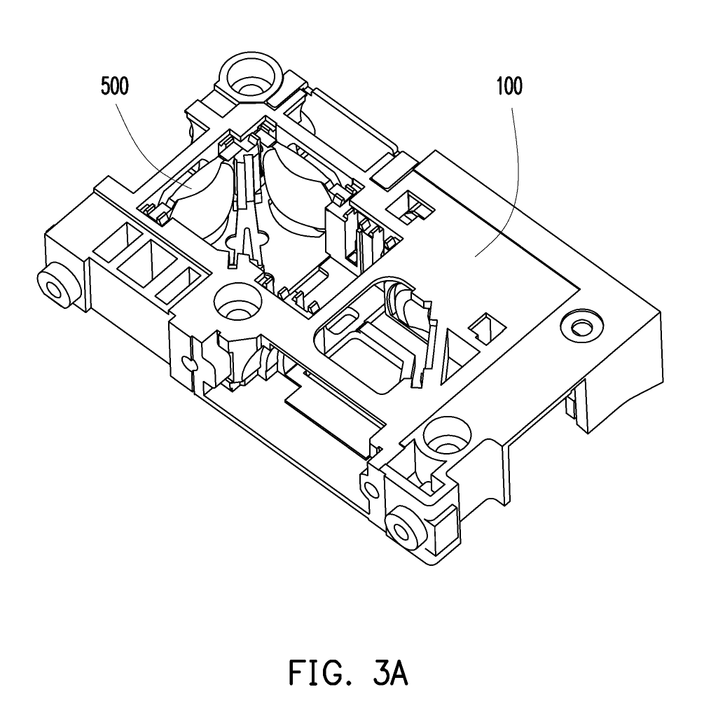

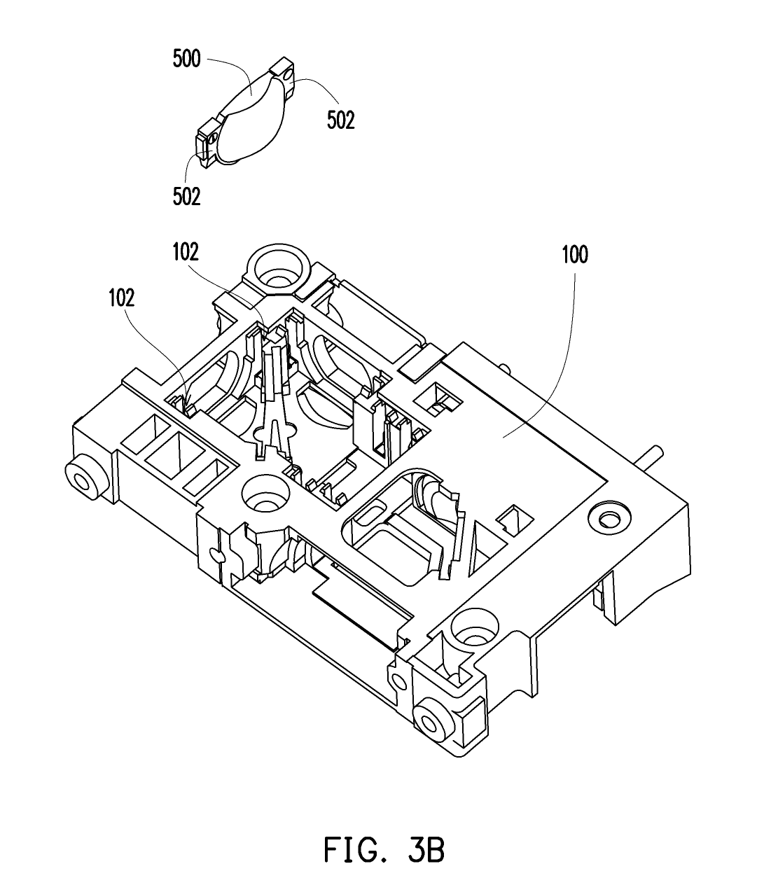

Referring to FIGS. 1, 3A, and 3B, in practice, to further align the lighting beam L1, the projection device 50 may further include an optical lens 500. The optical lens 500 is located on the transmission path of the lighting beam L1 and has a pair of embedded wings 502 on two sides of the optical lens 500 respectively. The optical engine base 100 has a pair of embedded slots 102 and the pair of embedded wings 502 is embedded in the pair of embedded slots 102 respectively. These characteristics facilitate the optical lens 500 to be located precisely on the optical engine base 100. Hence, the locating precision of the optical lens 500 may be increased so as to enhance the image quality of the projection device 502.

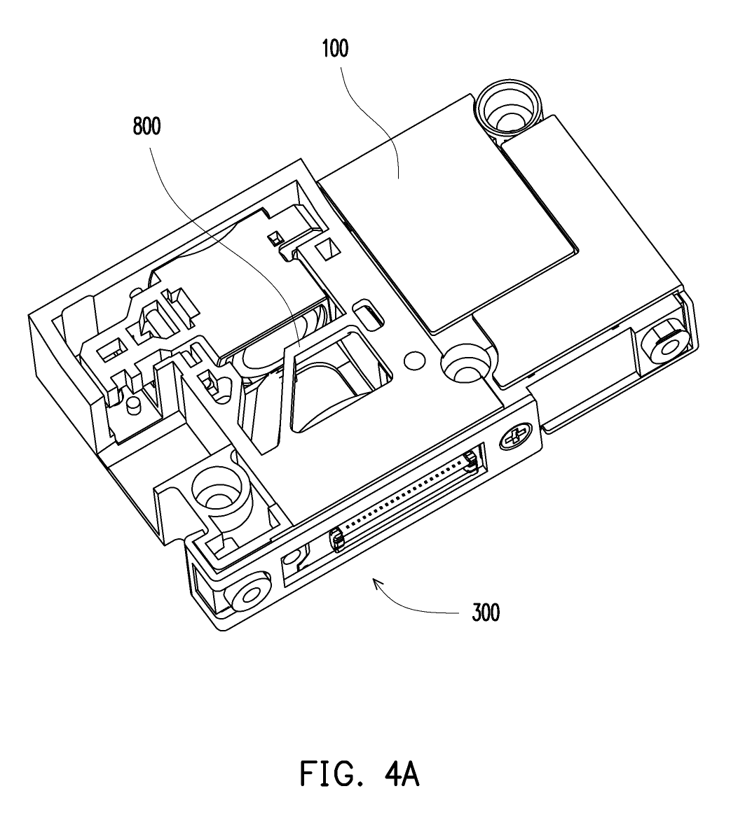

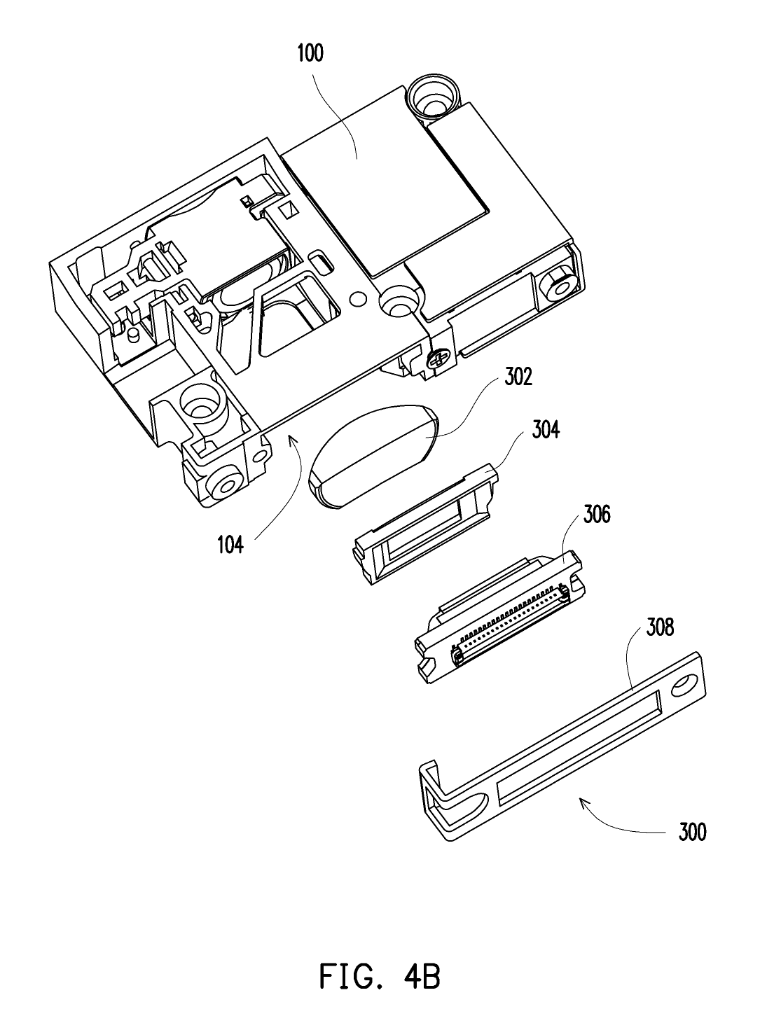

Referring to FIGS. 4A and 4B, the optical engine base 100 has a light valve slot 104 and the light valve 300 includes a field lens 302, an elastic frame 304, a light valve component 306, and a fixation holder 308. During the assembly, for instance, the field lens 302, the elastic frame 304, and the light valve component 306 are embedded in the light valve slot 104 sequentially. The fixation holder 308 is then assembled to the optical engine base 100 for the field lens 302, the elastic frame 304, and the light valve component 306 to be fixed to the light valve slot 104. The elastic frame 304 is fabricated with a rubber material, so that the elastic frame 304 may compensate with the field lens 302 to prevent dust from entering the light valve component 306.

Accordingly, one end of the fixation holder 308 (i.e. the left end) in the present embodiment may be buckled to the optical engine base 100 and the other end of the fixation holder 308 (i.e. the right end) may be screwed to the optical engine base 100. Nevertheless, the configuration of the fixation holder 308 and the method of fixing the fixation holder 308 to the optical engine base 100 is determined according to demands of the actual product. In other words, the design of the fixation holder in the invention is not limited to the description illustrated in the embodiments aforementioned.

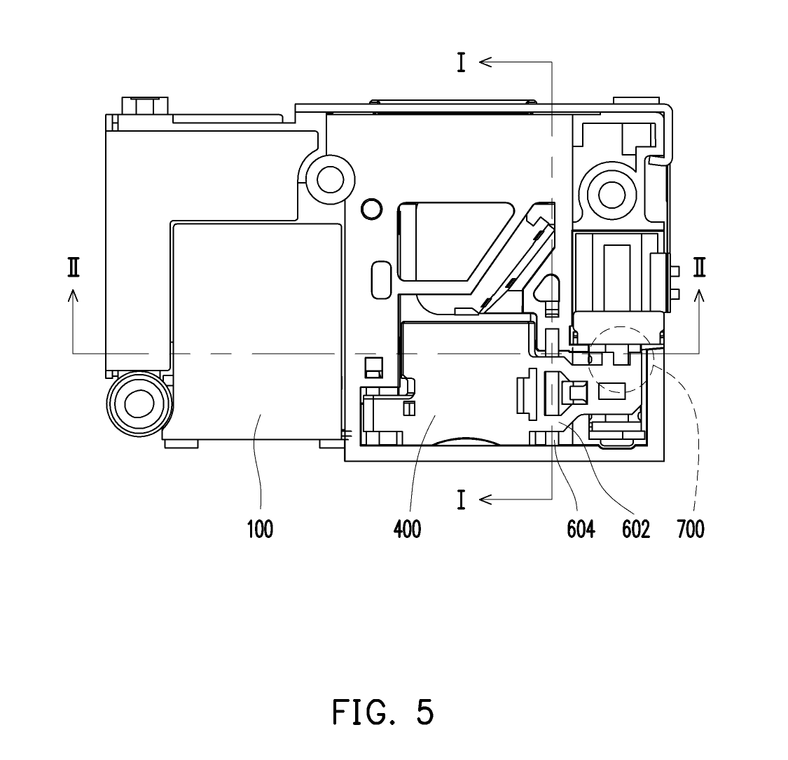

Referring to FIGS. 1 and 5, in the present embodiment, the projection device 50 further includes a slide block 602 and a slide rod 604. The slide block 602 is connected to the projection lens 400. In practice, the slide block 602 and a sleeve of the projection lens 400 are formed as an integrative unit, but the invention is not limited thereto. The slide rod 604 is mounted on the optical engine base 100 and compensated with the slide block 602, so that the projection lens 400 may move linearly along the slide rod 604 relative to the optical engine base 100 through the slide block 602. Here, the projection lens 400 moves along an up-and-down direction of the drawing in the present embodiment.

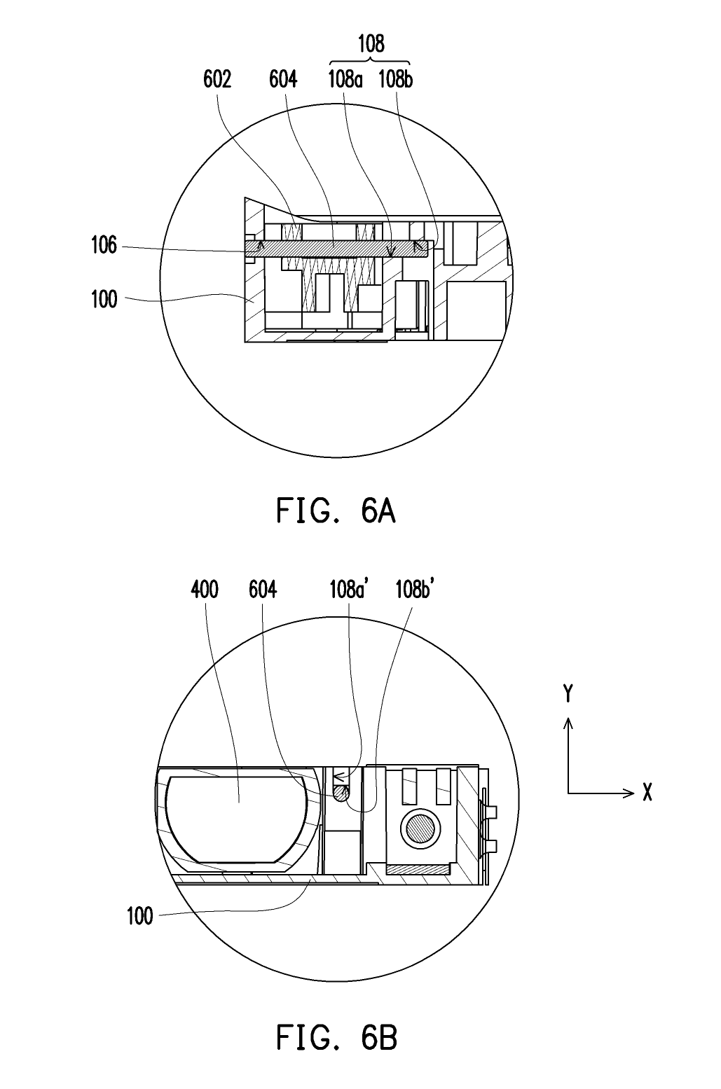

Referring to FIGS. 5, 6A, and 6B, in the present embodiment, the optical engine base 100 has a first mounting hole 106 and a second mounting hole 108, and two ends of the slide rod 604 compensate with the first mounting hole 106 and the second mounting hole 108 respectively.

Accordingly, in the present embodiment, the first mounting hole 106 is a circular axle hole and the second mounting hole 108 includes a first segment 108a and a second segment 108b. The first segment 108a is a U-shaped surface 108a′, as shown in FIG. 6B, configured to limit the slide rod 604 to move in both way along a first dimension (i.e. positive and negative direction of an X-axis in FIG. 6B) and in one way along a second dimension (i.e. negative direction of a Y-axis in FIG. 6B) on a two-dimensional plane (i.e. an X-Y plane in FIG. 6B) perpendicular to the slide rod 604. The second segment 108b has a planar surface 108b′, as shown in FIG. 6B, configured to limit the end of the slide rod 604 close to the second mounting hole 108 to move along the other way of the second dimension (i.e. positive direction of the Y-axis in FIG. 6B).

In the present embodiment, the first segment 108a and the second segment 108b are respectively formed by a top and a bottom molds. As a consequence, a molding yield rate of the second mounting hole 108 is increased.

Referring to FIG. 5, the projection device further includes a driver 700 mounted on the optical engine base 100 and coupled to the projection lens 400 for driving the projection lens 400 to move linearly along the slide rod 604 relative to the optical engine base 100 through the slide block 602. In the present embodiment, the driver 700 is a motor.

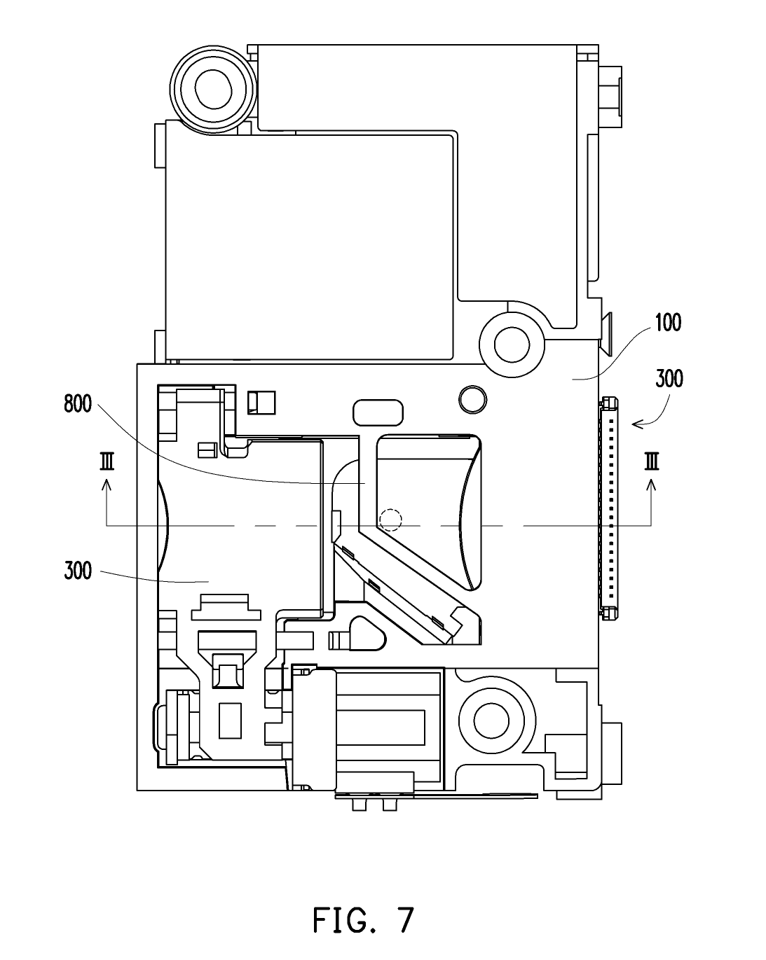

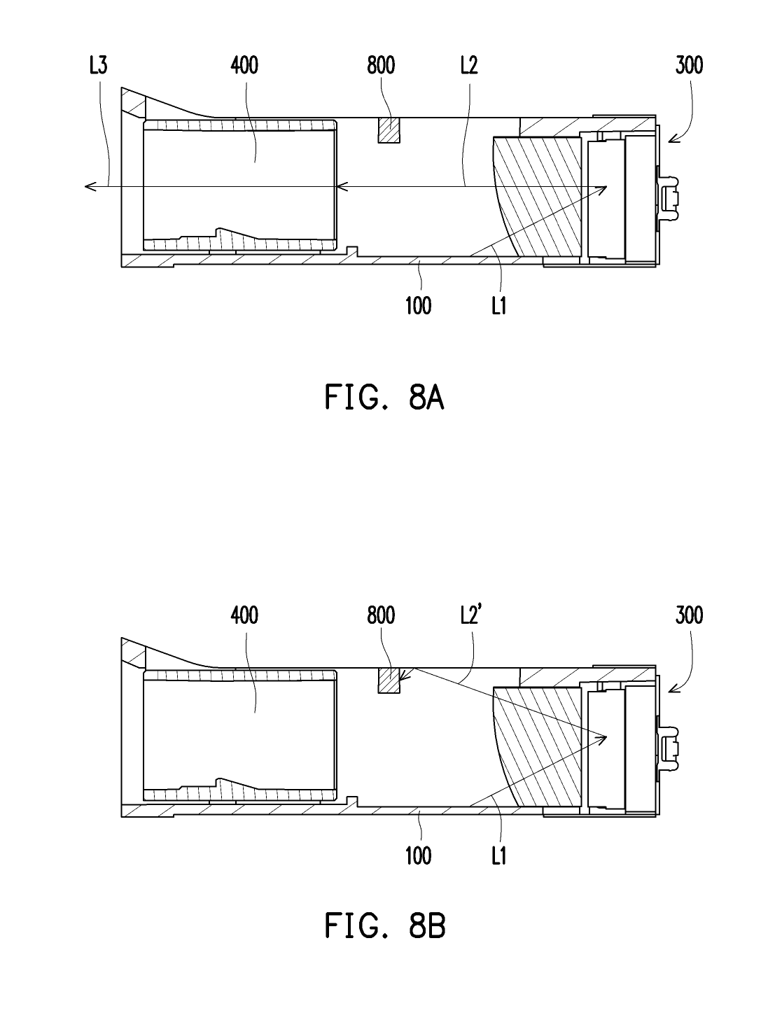

Referring to FIGS. 1, 4A, 7, and 8B, the projection device 50 further includes a shading body 800 (shown in FIG. 4A) located on a transmission path of a stray beam L2′ (shown in FIG. 8B) generated when the light valve 300 is in an off state, so as to shield the stray beam L2′. The shading body 800 is further illustrated in the following.

Referring to FIG. 8A, when the light valve 300 is in an on state, the light valve 300 converts the lighting beam L1 into the image beam L2 and the image beam L2 is further transmitted to the projection lens 400 so as to be converted into a projection beam L3 through the projection lens 400.

Conversely, referring to FIG. 8B, when the light valve 300 is in an off state, the light valve 300 forms a portion of the lighting beam L1 into an invalid beam L2′, and the invalid beam L2′ is further transmitted to the other areas. Here, the invalid beam L2′ is the lighting beam L1 being reflected to one of the areas when the light valve 300 is in an off state. Thus, the invalid beam L2′ is not transmitted to the projections lens 400. Nevertheless, in order to prevent the generation of stray light by the invalid beam L2′ after being reflected by the light valve 300 and transmitted by the projection lens 400, the shading body 800 is disposed on the transmission path of the invalid beam L2′. Thus, the invalid beam L2′ is prevented from being transmitted through the projection lens 400.

In the present embodiment, the shading body 800 and the optical engine base 100 are formed as an integrative unit when the optical engine base 100 is molded. The cost for fabricating the optical engine base 100 is therefore decreased and the fabrication of the optical engine base 100 is further simplified.

In summary, the embodiments of the invention include at least one of the following advantages or functions.

In the embodiments of the invention, the locating steps among the components may be simplified and the locating precision may be enhanced by the fitting and combination of the light component and the light lens with the component slot and the lens slot on the component holder respectively.

In the embodiments of the invention, the locating steps of the optical lens relative to the optical engine base may be simplified and the locating precision may be enhanced through the fitting of the embedded wings on the two sides of the optical lens and the embedded slots of the optical engine base.

In the embodiments of the invention, the components of the light valve may gradually filled into the light valve slot formed by the optical engine base, and the components may assembled to the optical engine base through the fixation holder of the light valve so as to simplify the assembly of the light valve.

In the embodiments of the invention, the first segment and the second segment of the second mounting hole of the optical engine base may be formed by a top and a bottom molds respectively. As a result, a molding yield rate of the second mounting hole is increased.

In the embodiments of the invention, the shading body may be set to be located on the transmission path of the image beam when the light valve is in an off state, such that the image beam in the off state is prevented from being transmitted through the projection lens to generate stray light, and the image quality is thus enhanced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all teems are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A projection device, comprising:
an optical engine base;
a light source, adapted to provide a lighting beam, comprising:
a component holder, assembled to the optical engine base, and having a component slot and a lens slot communicated with the component slot, wherein the lens slot has at least one slot section plane;
a light component, disposed within the component slot; and
a light lens, disposed within the lens slot and adapted to form a light generated by the light component into the lighting beam;
a light valve, assembled to the optical engine base, located on a transmission path of the lighting beam, and adapted to convert the lighting beam into an image beam; and
a projection lens, assembled to the optical engine base, located on a transmission path of the image beam, and adapted to convert the image beam into a projection beam.

2. The projection device as claimed in claim 1, wherein an outer edge of the component holder has at least one holder section plane, and the holder section plane is parallel to the slot section plane.

3. The projection device as claimed in claim 1, wherein an outer edge of the component holder has at least one sunken arc adapted to compensate a shape of an automatic locating detent.

4. The projection device as claimed in claim 1, further comprising:
an optical lens, located on the transmission path of the lighting beam and having a pair of embedded wings on two sides of the optical lens respectively, wherein the optical engine base has a pair of embedded slots and the pair of embedded wings is embedded in the pair of embedded slots.

5. The projection device as claimed in claim 1, wherein the light valve comprises:
a field lens;
an elastic frame;
a light valve component; and
a fixation holder,
wherein the optical engine base has a light valve slot, and the field lens, the elastic frame, and the light valve component are embedded in the light valve slot, and the fixation holder is assembled to the optical engine base so as to fix the field lens, the elastic frame, and the light valve component within the light valve slot.

6. The projection device as claimed in claim 1, further comprising:
a slide block, connected to the projection lens; and
a slide rod, mounted on the optical engine base and compensated with the slide block, so that the projection lens moves linearly along the slide rod relative to the optical engine base through the slide block,
wherein the optical engine base has a first mounting hole and a second mounting hole, two ends of the slide rod compensate with the first mounting hole and the second mounting hole respectively, the first mounting hole is a circular axle hole, the second mounting hole includes a first segment and a second segment, the first segment limits the slide rod to move in both way along a first dimension and in one way along a second dimension on a two-dimensional plane perpendicular to the slide rod, and the second segment limits the slide rod to move along the other way of the second dimension.

7. The projection device as claimed in claim 6, wherein the first segment is a U-shaped surface and the second segment is a planar surface.

8. The projection device as claimed in claim 6, further comprising:
a driver, mounted on the optical engine base and coupled to the projection lens for driving the projection lens to move linearly along the slide rod relative to the optical engine base through the slide block.

9. The projection device as claimed in claim 1, further comprising:
a shading body, located between the light valve and the projection lens.

10. The projection device as claimed in claim 1, wherein the shading body and the optical engine base are formed as an integrative unit.

11. The projection device as claimed in claim 1, wherein the component holder further has a component gluing slot and a lens gluing slot, and the light source further comprises:
a first glue body, disposed between the component gluing slot and the light component, so as to fix the light component to the component slot; and
a second glue body, disposed between the lens gluing slot and the light lens, so as to fix the light lens to the lens slot.

12. The projection device as claimed in claim 11, wherein the component gluing slot has a slant surface.
